(19) United States
(12) Patent Application Publication
(10) Pub. No.: US 2013/0154963 A1
(43) Pub. Date: Jun. 20, 2013

(54) ELECTRONIC DEVICE AND METHOD FOR CONFIGURING IMAGE EFFECTS OF PERSON IMAGES

(71) Applicant: CHO-HAO WANG, Tu-Cheng (TW)

(72) Inventor: CHO-HAO WANG, Tu-Cheng (TW)

(73) Assignee: HON HAI PRECISION INDUSTRY CO., LTD., Tu-Cheng (TW)

(21) Appl. No.: 13/568,053

(22) Filed: Aug. 6, 2012

(30) Foreign Application Priority Data
Dec. 14, 2011 (TW) 100146359

(51) Int. Cl. G06F 3/041

(52) U.S. Cl. 345/173

(57) ABSTRACT

In a method for configuring image effects of person images using an electronic device, an image configuration file and one or more image effect templates are stored in a storage system of the electronic device. A still person image is obtained from an image library stored in the storage system and displayed on a touch screen of the electronic device, and a face area of the still person image is identified according to a preset face characteristic value. The method detects a touch operation on the touch screen when the face area the still person image is touched, and selects one of the image effect templates from the storage system according to the touch operation. The selected image effect template is appended to the still person image to generate an animated person image, and the animated person image is displayed on the touch screen.

### BACKGROUND

1. Technical Field

Embodiments of the present disclosure relate to image processing systems and methods, and particularly to an electronic device and a method for configuring image effects of a person image.

2. Description of Related Art

Various methods are used for configuring animated images using a plurality of still images, where the animated graphics interchange format (GIF) image is widely used. An animated GIF is a vividly animated image on a web page. The animated GIF image is capable of infinitely looping or stopping after presenting one or several sequences. However, the animated GIF image cannot configure an animated graphic image displayed on a touch screen of an electronic device when a user touches a graphic image displayed on the touch screen.

Therefore, there is a need to provide an electronic device and a method to over come these above mentioned limitations.

### BRIEF DESCRIPTION OF THE DRAWINGS

FIG. 1 is a block diagram of one embodiment of an electronic device including an image configuration system.

FIG. 2 is a flowchart of one embodiment of a method for configuring image effects of a person image using the electronic device of FIG. 1.

FIG. 3 is a schematic diagram illustrating example for identifying a face area of a person image.

FIG. 4 is a schematic diagram illustrating example for generating an animated person image with an image effect when the person image is touched.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

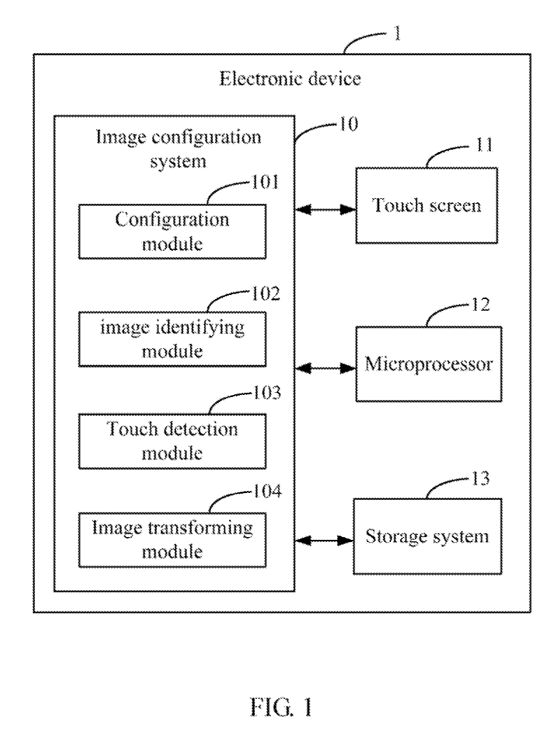

FIG. 1 is a block diagram of one embodiment of an electronic device 1 including an image configuration system 10. In the embodiment, the electronic device 1 further includes, but is not limited to, a touch screen 11, at least one microprocessor 12, and a storage system 13. The electronic device 1 may be a mobile phone, an electronic photo book, a notebook, or a personal digital assistant (PDA) device. The image configuration system 10 may include a plurality of functional modules that are stored in the storage system 13 and executed by the at least one microprocessor 12. FIG. 1 is only one example of the electronic device 1, other examples may include more or fewer components than those shown in the embodiment, or have a different configuration of the various components.

The image configuration system 10 configures image effects for a still image of a person (hereinafter “still person image”), and generates an animated person image with the image effects according to different touch operations on the still person image applied to the touch screen 11. In one embodiment, the animated person image can vividly present different expressions of the user, such as a smiling expression, a laughing expression, an angry expression, or a crying expression. The user may also append voices or sounds to the person image according to requirements of the user when the user touches the still person image displayed on the touch screen 11.

The touch screen 11 displays the still person image before the still person image is touched, and displays the animated person image when the still person image is touched. In one embodiment, the storage system 13 may be an internal storage system, such as a random access memory (RAM) for temporary storage of information, and/or a read only memory (ROM) for permanent storage of information. In some embodiments, the storage system 13 may also be an external storage system, such as an external hard disk, a storage card, or a data storage medium.

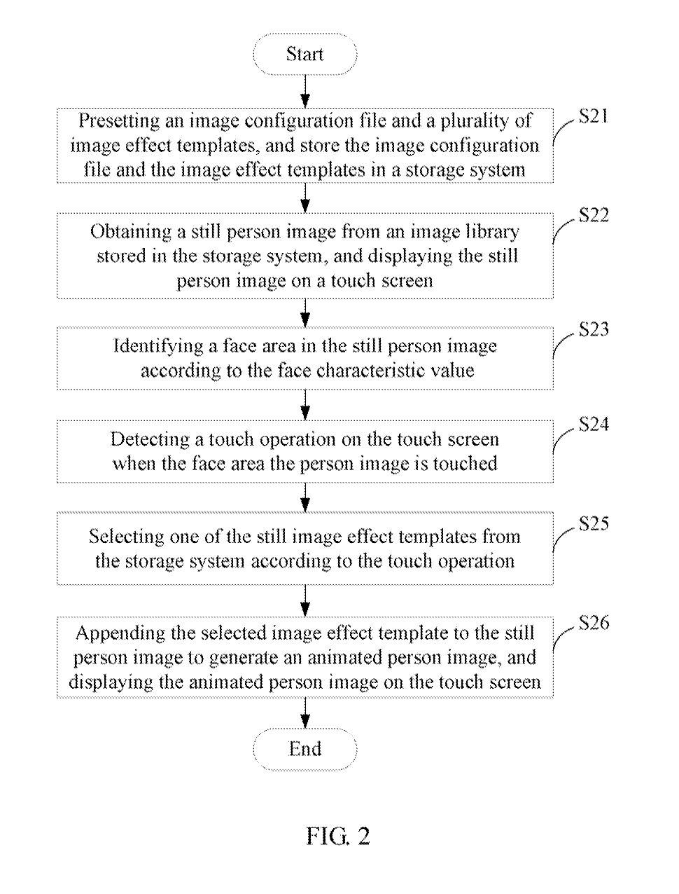

In one embodiment, the image configuration system 10 includes a configuration module 101, an image identifying module 102, a touch detection module 103, and an image transforming module 104. The modules 101-104 may comprise computerized instructions in the form of one or more programs that are stored in the storage system 13 and executed by the at least one microprocessor 12. Detailed descriptions of each module will be given in FIG. 2 as described in the following paragraphs.

FIG. 2 is a flowchart of one embodiment of a method for configuring image effects of a person image using the electronic device 1 of FIG. 1. Depending on the embodiment, additional steps may be added, others removed, and the ordering of the steps may be changed.

In step S21, the configuration module 101 presets an image configuration file and a plurality of image effect templates, and stores the image configuration file and the image effect templates in the storage system 13. In one embodiment, the image configuration file includes different image data that represent different expressions of the user, and audio data corresponding to the different expressions of the user. The expressions of the user may be a smiling expression, a laughing expression, angry expression or a crying expression, for example. Each of the expressions corresponds to a touch operation on the person image displayed on the touch screen 11. For example, if the user draws a circle on the person image, the touch screen 11 may display the person image with the laughing expression. If the user draws a cross on the person image, the touch screen 11 may display the person image with the angry expression. The image effect templates includes, but is not limited to, a smiling expression image, a laughing expression image, an angry expression image and a crying expression image. These images may be animated such that the images include animation of the person image smiling, laughing, crying, and/or being angry.

In step S22, the image identifying module 102 obtains a still person image from an image library stored in the storage system 13, and displays the still person image on the touch screen 11. In one embodiment, the storage system 13 stores an image library that includes a plurality of person images, and a face characteristic data for identifying a face area of each of the still person images. The face characteristic data may include a mouth characteristic data, eyes characteristic data, and noise characteristic data.

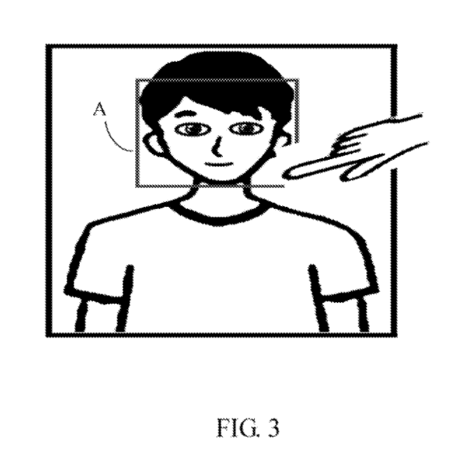

In step S23, the image identifying module 102 identifies a face area in the still person image according to a preset face characteristic value stored in the storage system 13. In one embodiment, the face characteristic value is a face similarity coefficient (e.g., a 95% similarity) that approximates a face of a person of the still person image. Referring to FIG. 3, the image identifying module 102 identifies the face area (denoted as the face area “A”) in the still person image if the face characteristic value is greater than the face similarity coefficient. The face area “A” includes a mouth part, an eyes part, and a noise part.

In step S24, the touch detection module 103 detects a touch operation on the touch screen 11 using a slide detector when the face area the still person image is touched. In one embodiment, the slide detector may be a pressure sensor or a thermal sensor. The touch operation may include, but is not limited to, an operation of drawing a circle on the face area, an operation of drawing a curve on the face area, an operation of drawing a line on the face area, or an operation of drawing a cross on the face area.

In step S25, the image transforming module 104 selects one of the image effect templates from the storage system 13 according to the touch operation. In one embodiment, if the touch operation is an operation of drawing a circle on the face area, an image effect template with a laughing expression is selected from the storage system 13. If the touch operation is an operation of drawing a cross on the face area, an image effect template with an angry expression is selected from the storage system 13.

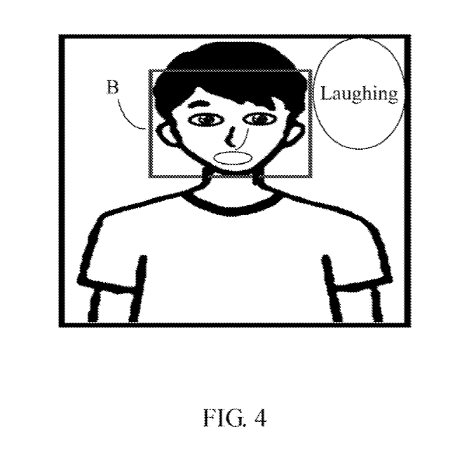

In step S26, the image transforming module 104 appends the selected image effect template to the person image to generate an animated person image, and displays the animated person image on the touch screen 11. Referring to FIG. 4, the touch screen 11 displays the animated person image “B” with a laughing expression when the user draws a circle or a curve on the face area “A” of the still person image.

All of the processes described above may be embodied in, and fully automated via, functional code modules executed by one or more general purpose processors of electronic devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a touch screen, a storage system, and at least one microprocessor; and
one or more programs stored in the storage system and executed by the at least one microprocessor, the one or more programs comprising:
a configuration module that presets an image configuration file and a plurality of image effect templates, and stores the image configuration file and the image effect templates in the storage system;
an image identifying module that obtains a still person image from an image library stored in the storage system and displays the still person image on the touch screen, and identifies a face area of the still person image according to a preset face characteristic value stored in the storage system;
a touch detection module that detects a touch operation on the touch screen when the face area of the still person image is touched; and
an image transforming module that selects one of the image effect templates from the storage system according to the touch operation, appends the selected image effect template to the still person image to generate an animated person image, and displays the animated person image on the touch screen.

2. The electronic device according to claim 1, wherein the face characteristic value is a face similarity coefficient that approximates a face of a person of the still person image.

3. The electronic device according to claim 2, wherein the image identifying module identifies an area of the still person image as the face area when the face characteristic value of the area of the still person image is greater than the face similarity coefficient.

4. The electronic device according to claim 1, wherein the image configuration file comprises different image data that represent different expressions of a user, and audio data that correspond to the different expressions of the user.

5. The electronic device according to claim 1, wherein the image effect templates comprise a smiling expression image, a laughing expression image, an angry expression image, and a crying expression image.

6. The electronic device according to claim 1, wherein the touch operation is an operation of drawing a circle on the face area, an operation of drawing a curve on the face area, an operation of drawing a line on the face area, or an operation of drawing a cross on the face area.

7. A method for configuring image effects of person images using an electronic device, the method comprising:
presetting an image configuration file and a plurality of image effect templates, and storing the image configuration file and the image effect templates in a storage system of the electronic device;
obtaining a still person image from an image library stored in the storage system, and displaying the still person image on the touch screen of the electronic device;
identifying a face area of the still person image according to a preset face characteristic value stored in the storage system;
detecting a touch operation on the touch screen when the face area of the still person image is touched;
selecting one of the image effect templates from the storage system according to the touch operation; and
appending the selected image effect template to the still person image to generate an animated person image, and displaying the animated person image on the touch screen.

8. The method according to claim 7, wherein the face characteristic value is a face similarity coefficient that approximates a face of a person of the still person image.

9. The method according to claim 8, wherein an area of the still person image is identified as the face area when the face characteristic value of the area of the still person image is greater than the face similarity coefficient.

10. The method according to claim 7, wherein the image configuration file comprises different image data that represent different expressions of a user, and audio data that correspond to the different expressions of the user.

11. The method according to claim 7, wherein the image effect templates comprise a smiling expression image, a laughing expression image, an angry expression image, and a crying expression image.

12. The method according to claim 7, wherein the touch operation is an operation of drawing a circle on the face area, an operation of drawing a curve on the face area, an operation of drawing a line on the face area, or an operation of drawing a cross on the face area.

13. A non-transitory storage medium having stored thereon instructions that, when executed by at least one microprocessor of an electronic device, causes the electronic device to perform a method for configuring image effects of person images, the method comprising:
presetting an image configuration file and a plurality of image effect templates, and storing the image configuration file and the image effect templates in a storage system of the electronic device;
obtaining a still person image from an image library stored in the storage system, and displaying the animated person image on a touch screen of the electronic device;
identifying a face area of the still person image according to a preset face characteristic value stored in the storage system;
detecting a touch operation on the touch screen when the face area the still person image is touched;
selecting one of the image effect templates from the storage system according to the touch operation; and
appending the selected image effect template to the still person image to generate an animated person image, and displaying the animated person image on the touch screen.

14. The storage medium according to claim 13, wherein the face characteristic value is a face similarity coefficient that approximates a face of a person of the still person image.

15. The storage medium according to claim 14, wherein an area of the still person image is identified as the face area when the face characteristic value of the area of the still person image is greater than the face similarity coefficient.

16. The storage medium according to claim 13, wherein the image configuration file comprises different image data that represent different expressions of a user, and audio data that correspond to the different expressions of the user.

17. The storage medium according to claim 13, wherein the image effect templates comprise a smiling expression image, a laughing expression image, an angry expression image, and a crying expression image.

18. The storage medium according to claim 13, wherein the touch operation is an operation of drawing a circle on the face area, an operation of drawing a curve on the face area, an operation of drawing a line on the face area, or an operation of drawing a cross on the face area.
